(19) United States
(12) Patent Application Publication
(10) Pub. No.: US 2014/0180651 A1
(43) Pub. Date: Jun. 26, 2014

(54) USER PROFILING FOR ESTIMATING PRINTING PERFORMANCE

(71) Applicant: XEROX CORPORATION, Norwalk, CT (US)

(72) Inventors: Svetlana Lysak, Lyon (FR); Guillaume Bouchard, Saint-Martin-Le Vinoux (FR); Jutta K. Willamowski, Grenoble (FR)

(73) Assignee: XEROX CORPORATION, Norwalk, CT (US)

(21) Appl. No.: 13/774,020

(22) Filed: Feb. 22, 2013

Related U.S. Application Data
(60) Provisional application No. 61/740,616, filed on Dec. 21, 2012.

(51) Int. Cl. G06F 19/24

(52) U.S. Cl. CPC G06F 19/24
USPC 703/2

(57) ABSTRACT

A computer-implemented system and method compute a reference behavior for a user, such as a new user of a set of shared devices or services. The method includes acquiring usage data for an initial set of users of the devices and extracting features from the usage data. A model is learned with the extracted features for predicting a user role profile for a new user based on features extracted from the new user's usage data. The user role profile associates the user with at least one of a set of roles. A new user's usage data is received and, with the trained model, a user role profile is predicting for the new user based on features extracted from the new user's usage data. A reference behavior is computed for the user based on the predicted user role profile and the reference behaviors for roles in the set of roles.

This application claims the priority of U.S. Provisional Application Ser. No. 61/740,616, filed on Dec. 21, 2012, the disclosure of which is incorporated herein by reference in its entirety.

### BACKGROUND

The exemplary embodiment relates to a system and method for promoting environmental behavior by users of consumables or services, such as users of shared electromechanical devices. It finds particular application in conjunction with a network printing system in which multiple shared printers are available to users for printing of print jobs and will be described with particular reference thereto.

To improve operations, both in terms of environmental impact and cost, organizations such as companies, government organizations, schools, residential facilities, and the like, have attempted to promote a more environmentally-conscious behavior in many areas of operation. However, to motivate users to change their habits in order to contribute to a collective objective is a complex matter, both at work and in society at large.

U.S. Pub. Nos. 20110273739 and 20120033250 disclose a Personal Assessment Tool (PAT) that helps to make its users aware of their individual print behavior. The aim is to motivate users to print only what really needed to support their job function and to consume (and waste) less. A feature of this tool is the simplicity with which it provides feedback to its users about their performance with respect to their print behavior. Performance feedback is given as a score, computed by comparing the user's observed behavior with a reference behavior, both of which can be expressed in terms of sheets consumed over a given period.

One problem with this approach is in setting a baseline against which a user's current behavior can be compared. One solution is for the individual user's reference behavior to be computed from his individual average past behavior. However, to compute a meaningful reference behavior for a user, a significant amount of historical data about the user's print behavior is needed for the behavior to be representative. A user's print behavior can vary significantly, depending on seasonal variations in the user's job function. Additionally, for new employees, such data may be available for only a short period of time and may not be very representative. Another problem with this approach is that users with initially poor reference behavior (those who print far more than is really needed to perform their job functions) have an advantage over those users with initially better print behavior in that it is easier for them to show significant improvements and thus may reap greater benefits provided by any incentives put in place for users showing improvements.

Alternative ways to compute the reference behavior can be considered to address these issues, for example, using the mean consumption observed within an organization, or across people having the same work role as the considered user. Both of these approaches are problematic. In the first case, the reference behavior may not be representative, as according to their role and activity, people may have very different printing needs, which should be reflected in different reference behaviors. The second case is only applicable if the individual users have very well established and definable work roles.

The present system and method facilitate the establishment of appropriate reference behaviors for users who have different consumption needs due to differences in their job functions.

### INCORPORATION BY REFERENCE

The following references, the disclosures of which are incorporated herein by reference in their entireties, are mentioned:

The following relate generally to encouraging users to make informed choices about printing: US Pub. No. 20110273739, published Nov. 10, 2011, entitled SYSTEM AND METHOD FOR PROVIDING ENVIRONMENTAL FEEDBACK TO USERS OF SHARED PRINTERS, by Maria Antonietta Grasso, et al.; US Pub. No. 20110310428, published Dec. 22, 2011, entitled SYSTEM AND METHOD FOR ENABLING AN ENVIRONMENTALLY INFORMED PRINTER CHOICE AT JOB SUBMISSION TIME, by Victor Ciriza, et al.; U.S. Pub. No. 20120033250, published Feb. 9, 2012, entitled VIRTUAL PRINTING CURRENCY FOR PROMOTING ENVIRONMENTAL BEHAVIOR OF DEVICE USERS, by Maria Antonietta Grasso, et al.; and U.S. Pub. No. 20090138878, published May 28, 2009, entitled ENERGY-AWARE PRINT JOB MANAGEMENT, by Christer E. Fernstrom, et al.

### BRIEF DESCRIPTION

In accordance with one aspect of the exemplary embodiment, a method for computing a reference behavior for a new user includes acquiring usage data for an initial set of device or service users, extracting features from the usage data, and learning a model with the extracted features for predicting a user role profile for a new user, based on features extracted from the new user's usage data, the user role profile associating the user with at least one of a set of roles. The method further includes receiving a new user's usage data and, with the trained model, predicting a user role profile for the new user based on features extracted from the new user's usage data. A reference behavior is computed for the new user based on the predicted user role profile and the reference behaviors for roles in the set of roles. One or more of the acquiring, extracting, learning, receiving, assigning and computing may be performed with a computer processor.

In another aspect, a system for computing a reference behavior for a new user includes a feature extractor for extracting features from usage data acquired for users of an associated set of shared devices. A role assignment component is provided for assigning a user role profile to a new user based on features extracted from the new user's usage data. The user role profile associates the user with at least one of a set of roles, the role assignment component employing a model learnt using features extracted from usage data of an initial set of users. A user quota component computes a reference behavior for the new user based on the user role profile and the reference behaviors for roles in the set of roles. A processor implements at least one of the feature extractor, role assignment component, and user quota component.

In another aspect, a method for computing a printing quota for a user includes providing a model for predicting a user role profile for a user based on features extracted from the user's print job data. The user role profile associates the user with at least one of a set of roles. The model is one which has been learned on features extracted from print job data acquired for a set of print jobs for each user in an initial set of multiple users. A new user's usage data is received and, with the trained model, a user profile for the new user is predicted, based on features extracted from the new user's usage data, the user profile assigning a probability to each of the roles in the set of roles. A printing quota for the user is computed with a processor, based on the user role profile and reference quotas for each of the roles in the set of roles.

### BRIEF DESCRIPTION OF THE DRAWINGS

FIG. 1 is a functional block diagram of a system for computing and using a user quota in accordance with one aspect of the exemplary embodiment;

FIG. 2 is a flow chart illustrating a method for computing and using a user quota in accordance with one aspect of the exemplary embodiment;

FIG. 3 is a flow chart illustrating a method for computing and using a user quota in accordance with one aspect of the method of FIG. 2, where roles for a subset of users are known;

FIG. 4 is a flow chart illustrating a method for computing and using a user quota in accordance with one aspect of the method of FIG. 2, where roles for a subset of users are not known;

FIG. 5 illustrates an exemplary graphical user interface for displaying a user's personalized quota;

FIG. 6 shows quotas computed for different roles and users and the deviation of the users from their quotas in terms of a score;

FIG. 7 shows quotas computed for different roles and users and the deviation of the users from their quotas in terms of a score;

FIG. 8 shows relative score computed for different users and the deviation of the users from their quotas; and

FIG. 9 shows relative score computed for different users and the deviation of the users from their quotas.

### DETAILED DESCRIPTION

Aspects of the exemplary embodiment relate to a system and method for estimating a device user's reference behavior and which allow computing a more appropriate and more comparable performance score for the user.

The exemplary embodiment is described in terms of a network printing system in which print jobs can be selectively directed from each user's workstation to one of a group of shared devices. The network devices are typically printers, copiers, or multifunction devices (MFDs), such as those with printing, copying and optionally faxing and email capability. Each user's actual usage of the shared devices can be determined and a score computed with a cost function which is based on the device usage, primarily the consumables used in executing jobs sent by the user to the devices. In the case of a print network, the consumables may be computed as the number of sheets of print medium used or other quantifiable measure of the consumables used in printing. The cost function may also take into account other factors in addition to the paper usage, which can be chosen to influence user's behavior while still allowing them to perform their required job functions efficiently.

The exemplary system and method find application in a Personal Assessment Tool (PAT), as described in above-mentioned U.S. Pub. Nos. 20110273739 and 20120033250. Such a tool can provide information about the individual's behavior and its impact on the environment through a user interface which is easy to understand. The exemplary PAT system can also be used for setting goals for the user and may allow comparison with the behavior of other users which, overtime, can lead to improvements in behavior.

To determine the impact of the user's printing behavior on the environment, the PAT computes a cost for each action (print job), which is defined in a virtual currency, called Green Points (GP). In an example embodiment, the cost of an action is equal to the number of sheets used plus a penalty. The cost of a print job can be primarily a function of the number of sheets printed, because the impact on the environment is mainly determined by the printing volume. However, the printing cost formula also adds penalty costs for particular environmentally unfriendly behaviors. The user may be allocated a certain number of green points in a given period, which is consumed based on printer usage according to the cost function. It is to be appreciated, however, that the green currency is also applicable to the use of other shared resources (such as devices or services) where users have a choice as to how much use to make of the resource.

The computed cost of each action is then used to compute the user's mean monthly consumption, which in the existing system, serves as the user's reference behavior for providing a personalized quota. For subsequent months, the user's target is based on the personalized quota, with the expectation that the user will try to consume less. The user's GP consumption is thus permanently compared to his personalized GP quota. This difference between the user's personal quota and his actual consumption, the so-called GP savings or score, is then used to display feedback to the user and to provide tangible or intangible rewards.

The present system and method, which can incorporate the PAT system, except as noted, provides an alternative method for estimating the users' reference behaviors, which avoids the need to collect historical print logs for every user over an extended period. This allows the users to obtain feedback without waiting for 12 months of data to be collected, for example. It also provides for a user's reference behavior to take into account the behaviors of other users with similar roles in the organization. Thus, users with undesirable initial behavior do not automatically benefit over others with similar roles that are more careful regarding their usage.

Briefly, in the exemplary method, a user's role profile is generated which helps to identify users with the same/similar behavior and uses the pattern or group to which a user belongs to compute the reference behavior, which can serve as the user's personal quota. This helps to avoid dependencies on time and extraordinary events. User role profiles can also help to evaluate each user's behavior in terms of whether they are environmentally friendly or not, and whether they are improving or deteriorating, not only in terms of the user's own behavior but also in comparison with others.

In the method, historical print logs of an initial set of users are acquired and used to construct a feature set from which a feature profile can be extracted for each initial user. The print logs are each annotated according to the role of the initial user, or when users have multiple roles, the role associated with the print log. Using the feature profile, the user can be assigned a role profile which is used to determine the user's quota. In place of the quota estimation formula of the prior PAT system (which uses the historical monthly mean consumption of a user), the current quota and the user's score are more representative of the group to which the user belongs, allowing an improved comparison and evaluation of the users' behavior, including for new users for which extensive historical print logs are unavailable.

The term “printer,” as used herein, broadly encompasses various printers, copiers, bookmaking machines, or multifunction machines, xerographic or otherwise, unless otherwise defined, which performs a print job rendering function for any purpose.

A “printer network,” as used herein incorporates a plurality of shared devices, which are accessible to one or more workstations, such as personal computers.

The term “print medium” generally refers to a physical sheet of paper, plastic, or other suitable physical print media substrate for images, whether precut or web fed.

A “print job” generally includes a “printing object,” which consists of one or more document images in a suitable format that is recognized by the printer, e.g., Postscript, together with a “job ticket,” which provides information about the print job that will be used to control how the job is processed. The present method can extract features based on the printing object and/or on the information extracted from the job ticket.

### User Role Profile

It may be assumed there is a number R of different roles (job functions) in an organization, such as a company, which can be assigned to persons (users) in the organization. Each role may involve the user in printing at least some print jobs during the course of a given assessment period, such as a week or month. However, it is assumed that the different roles may each have a different quota (a role quota), due to the different printing needs of the different roles. Personalized quotas for individual users in the organization are computed based on the quota(s) of the roles which they perform in the organization.

Each user in the organization may have a single role or a probabilistic distribution over all roles (the user's role profile). For a given user with predicted role probabilities p₁, p₂, . . . p_{R}, for roles R=1 to R, the user's personal quota q may be computed as a function of the role probabilities, e.g., using a weighted average of the role quotas q₁, q₂, q_{R}:

q=Σᵣ^{R}pᵣqᵣ (Eqn. 1)

In this formula, it is assumed that the role probabilities sum to a predetermined value, e.g., p₁+p₂+ . . . p_{R}=1

For each role, a role quota qᵣ is assigned, which can be different for each role, to account for the fact that different roles have different printing needs in order to fulfill the role effectively. The role quotas q₁, q₂, q_{R} may be decided by organization personnel. In other embodiments, the quota for each role is based at least in part on historical usage data for a set of users performing that role. The role quota may be expressed in terms of measurable quantity of a consumable used, such as sheets of paper or pages printed.

The role quota may be determined in a variety of ways. For example, the role quota may be the average print volume for all the users in a group that have a given role, or be a function of that amount. In one embodiment, the roles of the initial users are manually assigned, e.g., by an administrator or estimated by the employees. For example, roles may be proportionately assigned from a predefined set or hierarchy of roles. For example, they may be selected from a plurality of roles, such as {administrative, research, management, sales, etc.}. The role quota can then be computed based on this information as the average number of sheets (or other suitable measure) which a user having only that role would consume in a given period.

The personalized quotas computed using the role quotas need not provide a hard limit on the number of prints that the user is permitted to generate in a measurement period, but may be used to establish a reference point to which users can compare their performance. Each user in the organization may be assigned their respective quota. In some embodiments, rather than a personalized quota, a number of units or “points” may be assigned, which are attributed to users' accounts for each assessment period in amounts which are a function of the respective user's quota. In some embodiments, if the quota is determined in number of sheets, they may be awarded one point for each sheet. The units are then consumed, according to a cost function, taking into account not only the number of sheets/pages printed but also other factors designed to modify user behavior, such as one or more of: whether the same or a similar document has already been printed by the user in a prior print job (which is referred to as repeat printing, and is treated differently from making multiple copies of the same document in a single job, which can be considered a part of the job function, e.g., to distribute to others), whether the user has selected duplex (two-sided) or simplex (single-sided) printing, the type of job, (potentially penalizing the user for printing document types that should typically not be printed (such as Email, or PowerPoint presentations), and the like, e.g., using a cost function as disclosed for example, in U.S. Pub. No. 20120033250.

Role probabilities p₁, p₂, . . . p_{R}, of users in the organization can be computed by various methods. In one method, a supervised learning method is used. This assumes that there is a predefined set of user roles and that each of a subset of the users (e.g., an initial set of users) has been assigned one or more of these roles. In another method, an unsupervised learning approach is used. This method is suitable for the case where determining a priori roles for the users is difficult.

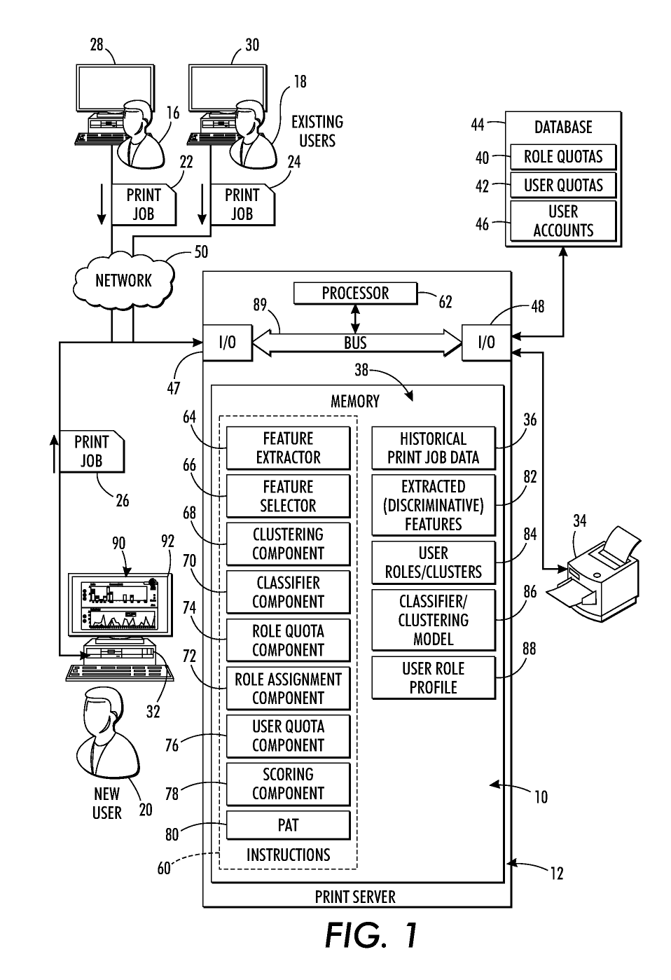

FIG. 1 illustrates an exemplary system 10 for determining a reference behavior q for each of one or more users in a set of users in an organization in which users have different roles. The system 10 is described in terms of users of a printing network in which users submit print jobs to be printed on a print medium, although other uses for the system are also contemplated, such as for monitoring usage of other materials and/or services, and the like.

The system 10 may be hosted on any suitable computing device or devices 12, such as a print server of a printing network 14, or the like. Users 16, 18, 20 of the printing network 14 submit their print jobs 22, 24, 26 from respective client computing devices 28, 30, 32, such as PCs, laptops, or the like, for printing on one or more printers 34 in the printing network 14. Printers 34 may be controlled by computing device 12 or a separate print server. The data 36 from the print jobs 22, 24 submitted by an initial set of users 16, 18 is acquired over a period of time by the system 10 and stored in memory 38 of the system 10 or remote accessible memory. The data 36 may be acquired from the client computing devices 28, 30, the printers 34, a print server which routes print jobs to the printers, a combination thereof, or from another memory storage device. Role quotas 40 and individual user quotas 42 generated by the system 10 may output, e.g., to the client devices 28, 30, 32, to a database 44 stored on remote memory, and/or may be stored locally in system memory 38. Individual accounts 46 of the users may be credited with the respective individual quota each assessment period (such as monthly) and the accounts depleted as the user prints print jobs. The system 10 may communicate with external devices 28, 30, 32, 34, 44 via one or network interfaces 47, 48 over a wired or wireless network 50, such as a local area network or a wide area network, such as the Internet.

As will be appreciated, while only two initial users 16, 18, are illustrated in FIG. 1, the system 10 generally receives historic print job data 36 from a much larger group of initial users, such as at least ten or at least twenty initial users. Further, in one embodiment, the initial set of users covers all the roles in a set of roles, such as at least two, or at least three, or at least four, or at least ten roles within an organization, whereby each of at least some of the roles are associated with a plurality of users. The print job data 36 can be preprocessed to reduce noise, e.g., by eliminating low-volume users from the dataset 36.

Memory 38, or a separate memory, stores instructions 60 for performing the exemplary method, which are executed by a computer processor 62 communicatively connected with the memory. The exemplary instructions 60 include a feature extractor 64, an optional feature selector 66, a model generator, such as a clustering component 68 or classifier component 70, a role assignment component 72, a role quota component 74, a user quota component 76, and optionally a scoring component 78 and a personal assessment tool (PAT) 80.

Each print job 22, 24, 26 is assumed to have a set of attributes, such as document type (Word, Excel, PowerPoint, PDF, Email, etc.); document length, e.g., in pages; document textual content, e.g., title, keywords, and the like; date and time of submission; color or black and white (monochrome); simplex or duplex; and so forth, which can be extracted from the print job data. The feature extractor 64 computes features 82 based on these attributes for each of the initial set of users 16, 18, for whom there is sufficient print job data 36. Some of these attributes may not be useful in characterizing user roles and thus only the most discriminating attributes need be stored and used to generate features 82. In one embodiment, the feature selector 66 evaluates the possible features to identify the most discriminating ones, allowing less useful ones to be ignored. In other embodiments, an administrator or system designer selects the features that are to be used. The clustering component 68 used in the unsupervised learning case, clusters the initial users 16, 18 into clusters 84, based on their respective sets of features. Each cluster can be considered as corresponding to a different role. Accordingly, where reference is made to role probabilities and role quotas, these may be considered as encompassing the respective probabilities and quotas for clusters in this embodiment.

In the supervised learning case, the roles (role profiles) 84 of the initial users 16, 18 are received by the system 10. The classifier component 70 learns a classifier model 86 based on the print job features (feature profiles) for these users and their respective known role profiles 84, using any suitable classifier learning method. The trained model 86 is thus configured for outputting an individual role profile, for a new user based on that user's feature profile.

The role quota component 74 computes a quota qᵣ 40 for each role/cluster in the set of roles/clusters 84, e.g., based on the usage of the users assigned to that role/cluster. For example, the role quota is computed from the print job data for those users having that role, e.g., as the average consumption (e.g., the mean number of sheets used or pages printed) by this group of users (or computed using a cost function as described above). Where an initial user has two or more roles, the consumption may be split between the roles, e.g., based on the role probabilities, e.g., the proportion of his time allocated to each role, or other suitable method of allocation.

In other embodiments, the role quotas qᵣ are manually assigned, e.g., based in part on observations of the consumption by users having a given role.

The role assignment component 72 assigns a role profile 88 composed of role probabilities Pᵣ for one or more roles to a new user 20, (or existing user 16, 18) based on features extracted from their available print job data 36. In the unsupervised case, the role assignment component 72 (which can be or call on the clustering component 68) predicts the cluster (i.e., role) probabilities for a new user, based on extracted features of a selection of print jobs. For this, the clustering model 86 (which stores the parameters of the clusters) generated by the clustering component can be used. In the supervised case, the classifier model 86 is utilized by the role assignment component 72 to compute an assignment of the roles.

The user quota component 76 computes a personal quota q for the user, based on the user's role profile 88, output by the role assignment component 72, and the respective role quotas qᵣ 40, e.g., using Eqn. 1 above. The user's quota q, which can be for a month or any other predetermined assessment period, can be displayed to the user in a user interface, used by the scoring component 78 to compute a score based on the actual usage for the month, used to provide rewards for adhering to the quota or using less than the quota, or combination thereof, as described in U.S. Pub. No. 20120033250. In one embodiment, the PAT 80 generates a user interface for displaying the user's quota, score, and/or other information on the user's client device and may be hosted in whole or in part by the client device.

The computing device 12 may be a PC, such as a desktop, a laptop, palmtop computer, portable digital assistant (PDA), server computer, cellular telephone, tablet computer, pager, combination thereof, or other computing device capable of executing instructions for performing the exemplary method.

The memory 38 may represent any type of non-transitory computer readable medium such as random access memory (RAM), read only memory (ROM), magnetic disk or tape, optical disk, flash memory, or holographic memory. In one embodiment, the memory 38 comprises a combination of random access memory and read only memory. In some embodiments, the processor 62 and memory 38 may be combined in a single chip. The network interface (I/O) 47, 48 allows the computer to communicate with other devices via a computer network 50, such as a local area network (LAN) or wide area network (WAN), or the internet, and may comprise a modulator/demodulator (MODEM) a router, a cable, and/or Ethernet port.

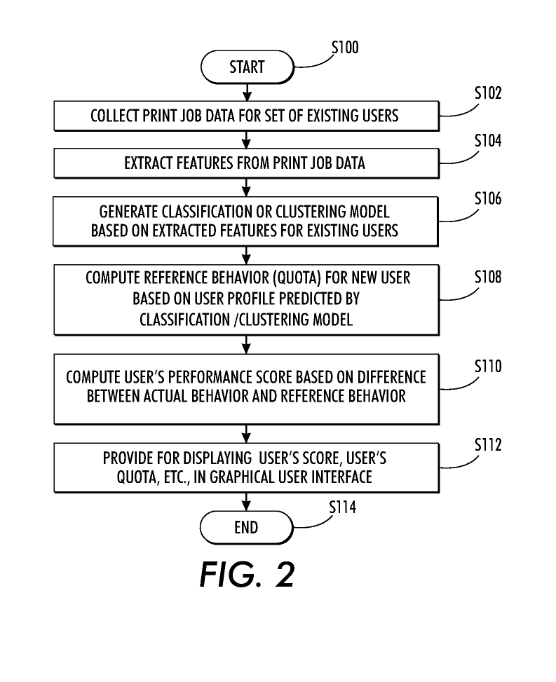

The digital processor 62 can be variously embodied, such as by a single-core processor, a dual-core processor (or more generally by a multiple-core processor), a digital processor and cooperating math coprocessor, a digital controller, or the like. The digital processor 62, in addition to controlling the operation of the computer 12, executes instructions stored in memory 38 for performing the method outlined in one or more of FIGS. 2-4. Hardware components 38, 47, 48, 62 of the system communicate via a data/control bus 89.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

As will be appreciated, FIG. 1 is a high level functional block diagram of only a portion of the components which are incorporated into a computer system 10. Since the configuration and operation of programmable computers are well known, they will not be described further.

FIG. 2 illustrates the exemplary method for computing and using a user quota which can be performed with the system of FIG. 1.

The method begins at S100.

At S102, print actions are observed for an initial set of users, for example by acquiring print job logs 36. These may be acquired from the printers themselves, from the users' computing devices, or from a server which collects the data. For each print job, a set of attributes is obtained, specific examples of which are given below. In some embodiment, these attributes may be extracted from the print jobs as an attribute vector or “signature” at the time of printing. The attributes may relate to the time of the print job, type, content, simplex vs. duplex, printer used, paper type, whether color or black and white is selected, degree of coverage (how much of the page receives ink or toner), cost, which may take into account one or more of these attributes, and so forth. The raw or preprocessed data 36 is received by the system and stored in memory 38.

At S104, features are extracted from the print job logs, by feature extractor 64. Exemplary features, which are computed based on the print job log attributes, include features for each user. As an example, these can be selected from:
1. a) number of sheets printed, b) number of print jobs printed, c) average number of sheets per print job, per predefined time period (e.g., per hour, per day, per week of the month, per week of the year, per month of the year, etc.);
2. a) number of sheets printed, b) number of print jobs printed, c) average number of sheets per print job, per predefined job type for each of a predefined set of job types (e.g., selected from Email; spreadsheet, such as Excel; graphics; PDF; PowerPoint; RTF; Text; drawing program, such as Visio or Chemdraw; Web page; Word, other);
3. a) number of sheets printed, b) number of print jobs printed, c) average number of sheets per print job, per printer, for each of a set of printers.
4. textual content features, such as word frequencies of each of a selected set of words, extracted from the title or content of the printed document.

The feature values may each be normalized to a 0-1 range and the feature vectors may also be normalized so the values sum to 1.

At S106, a role prediction model 86 (classifier model or clustering model) is learned, based on the features extracted from the user data of the existing users, and in the supervised case, the roles (role profiles) of the initial users, e.g., by model generator 68 or 70.

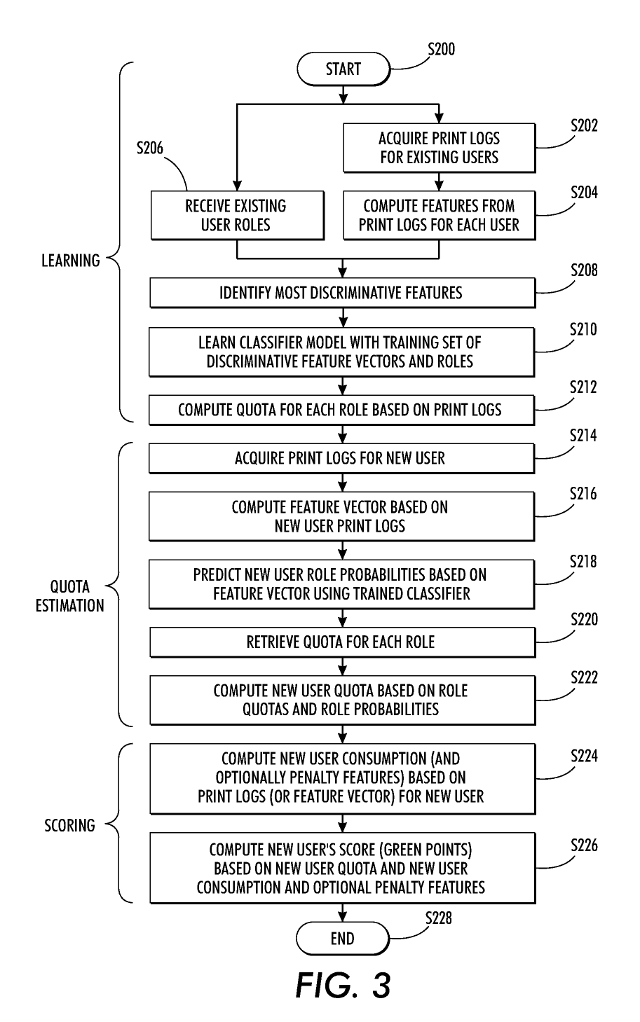

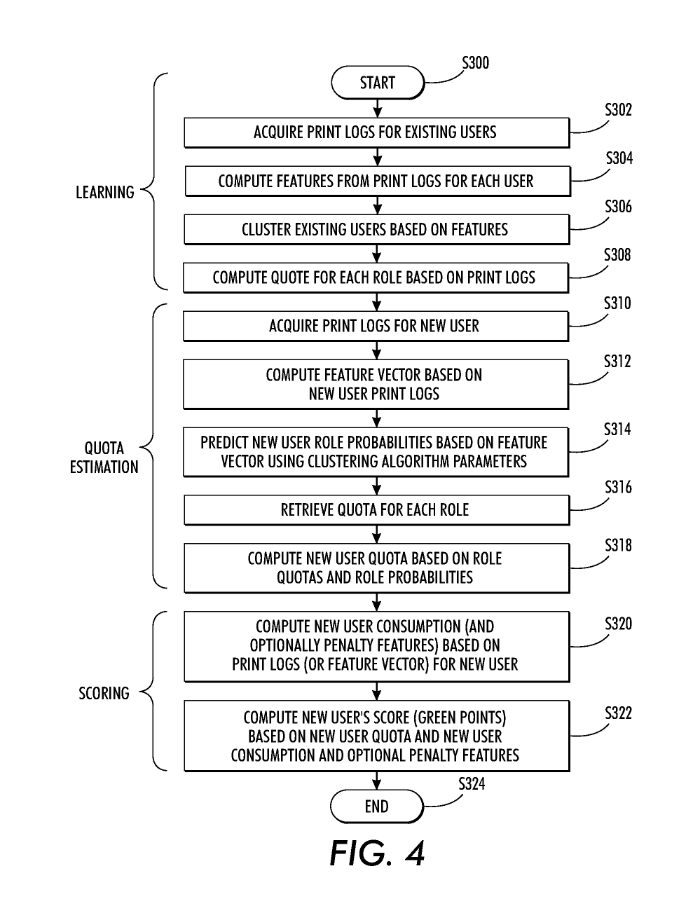

At S108, the reference behavior (quota) q for a new (or existing) individual user 32 is determined by component 76. As described in further detail with respect to FIGS. 3 and 4, this may include applying the learned model 86 to features extracted from print job data for the new user to predict the new user's profile, in terms of probable roles/clusters (e.g., expressed as a probability for each role). The user's quota is then determined based on predefined role/cluster quotas and the user's profile.

At S110, the user's performance score may be computed by the scoring component 78 as the absolute and/or relative difference between his actual behavior and his reference behavior as computed at S108.

Once computed, the reference behavior can also be used as a basis for defining print governance rules that introduce a hard printing consumption limit for its users.

At S112, a graphical representation 90 of the user's quota and/or performance score is generated by the personal assessment tool 80 and output to be displayed to the user on the display device 92 (e.g., computer monitor, LED or LCD screen, or the like) of the user's client device 32. The graphical display may be updated as each print job is executed, or less frequently. A comparison with other users having the same (or similar) role profile may be provided and displayed on the user interface.

The method ends at S114.

The reference behavior (S108) for each individual user can be computed in different ways, depending on whether there are predefined roles.

If roles are pre-defined and available for a subset of users, a supervised learning approach can be applied. In this case, reference behavior models corresponding to these user roles are first learned from the set of print jobs issued by all the corresponding users. Each individual user's observed behavior is then analyzed and the probabilities of belonging to each of the different roles, given his observed print behavior, is determined. Then, the overall user's reference behavior is computed as the weighted sum of the corresponding roles' reference behaviors, the weights being the probabilities that the user belongs to that role. FIG. 3 illustrates this case in further detail.

If roles are not pre-defined and available for a subset of users, an unsupervised learning approach is employed. In this case the individual user's reference behavior is determined based on the behavior of similar users. Specifically, print jobs are clustered based on features extracted from the print job data at to obtain clusters of (users, features). As an example, the features can represent the occurrence of a word in the title or the body of the document. Each individual user's observed behavior is then analyzed and the proportion of jobs belonging to each of these clusters, given his observed print behavior, is determined. The reference behavior for each individual user is then determined as a weighted sum of the corresponding clusters. FIG. 4 illustrates this case in further detail.

Further details of the system and method will now be described.

### Supervised Learning Case

Supervised learning or classification assumes that a training set with predefined classes or categories is available. For user profiling, the training data is obtained from the printing logs and the classes are defined according to the users' roles in the company.

For multiclass classification, several well-known algorithms are available, one or more of which can be used by the classifier component 70. Example learning algorithms include Support Vector Machines (SVM), which can be coupled with Sequential Minimal Optimization (SMO), Logistic Regression (LR), and Fisher Linear Discriminant (FLD). The LR algorithm uses a weighted least squares algorithm, i.e., the prediction is based on construction of a regression line as the best fit through the data points by minimizing a weighted sum of the squared distances to the fitted regression line. SVM, in contrast, tries to model the input variables by finding the separating boundary—called hyperplane—to reach classification of the input variables: if no separation is possible within a high number of input variables, the SVM algorithm still finds a separation boundary for classification by mathematically transforming the input variables by increasing the dimensionality of the input variable space. FLD seeks to reduce the dimensionality while preserving as much of the class discriminatory information as possible. Classifier accuracy, such as error rate, precision, recall, receiver operating characteristic (ROC) area, execution time, combination thereof, or the like can be used to select the most appropriate classifier, given the types of features selected. Relevant parameters of the classifier may be selected, for example, by evaluating the error rate of the classifier on a labeled training set.

FIG. 3 illustrates one embodiment of the supervised learning case in greater detail. The method includes a training stage, a quota estimation stage, based on a prediction of the role for a user, and a scoring phase which can include computation of green points.

As for the embodiment of FIG. 2, print logs are acquired (S202) and used (by feature extractor 64) to compute a set of features 82 for each user in an existing (initial) set of users (S204). The roles for each of the existing users are also acquired (S206). The user roles may be defined by management. For example a user could be assigned 50% of his time to the management role and 50% to the administrative role. The role distributions can be based on observing the amount of time users spend on each role, or by conducting surveys of users as to how much time they spend on each role. Users with the same job description may be assigned the same distribution of roles. Or the role distributions can be identified having users annotating print jobs with respective role labels, the user can then be assigned to the roles in proportion to the number of sheets of his or her print jobs allocated to each role.

Where a large number of possible role classification features are available, it may be desirable to identify the most discriminative features (S208). To identify how discriminative features are to the user role classification, a statistical hypothesis test can be used, such as the student t-test. Those features which are not significantly different, according to the test, between a given role and other roles, can be omitted from further consideration. As will be appreciated, the classifier model could learn the most discriminative features without any need to select them. However, selecting the most discriminative features in advance can help to reduce computation time.

At S210, a classifier model is learned using the (discriminative) features for each of the initial users (computed at S204) and their respective assigned/determined roles. For example a multiclass classifier returns a classification model by returning its parameter vector. The model parameters 86 are stored for the future predictions of a user's role, based on that user's features.

At S212, a role-based reference behavior (e.g., a quota) qᵣ is computed for each of the predetermined roles based on the consumption of those users with that role. The role-based reference behavior can be computed from the feature vectors (or print logs) for the users having a given role. This completes the learning phase, which can be repeated and the classification model 86 and/or reference behaviors updated at any time.

In the quota estimation stage, a new (or existing) user 20 who needs to get a personalized quota q is introduced in the system. The users feature profile is computed, e.g., based on only the most discriminative features (identified in the training phase). The probability of allocating the user to each role pᵣ is computed by using the classifier model. For example, at S214, print logs are acquired for the new user. At S216, a feature profile (e.g., as a vector) is computed based on the new user's print logs, for the most discriminative features. At S218, the new user's role probabilities are predicted by applying the trained classifier model 86 to the user's feature vector. The classifier outputs a probability pᵣ for each role. At S220, the quota qᵣ for each role computed at S210 is retrieved from memory and at S222, the new user's quota is computed, based on the retrieved role quotas and new user's role probabilities pᵣ, e.g., with Eqn. 1.

Once the user's quota q has been estimated, it can be stored in memory 44, and may be used in scoring the user's behavior. For example, the actual usage can be computed (S224) and the user's score computed (S226) as the difference between the user's quota q and the actual usage, optionally taking into account penalty features as described in US Pub. No. 20120033250. The method ends at S228.

### Unsupervised Learning Case

Unlike in the supervised learning case, unsupervised learning does not assume that the roles of at least some of the users in the company are known. In this case, the print usage patterns that indicate users with similar printing behavior are automatically identified so that users can be clustered in to clusters, each cluster loosely corresponding to a role.

In the unsupervised case, the input data is composed only of the user features extracted from the users' print logs 36. The logs are used to construct the user features as in the supervised case, but here the feature vectors are input to the unsupervised learning algorithm, which results in clusters of similar feature vectors. A quota qᵣ is computed for each of the clusters and stored for the computation of a quota for a future new user. Once a new user with his or her feature vector is added to the system, the clustering algorithm with saved parameters of the model assigns the user to a cluster or probabilistically over all clusters. Knowing the user's cluster probabilities Pᵣ, the personal quota can be obtained. To compute the user's score, the user's actual consumption is compared with personal quota obtained for the user.

FIG. 4 illustrates the unsupervised learning method in accordance with one embodiment. The method begins at S400.

As for the embodiment of FIGS. 2 and 3, printer logs 36 are acquired (S302) and used (by feature extractor 64) to compute features 82 for each user (S304) in an existing set of users 16, 18. At S306, a clustering algorithm 68 is used to cluster the initial users into clusters, based on similarity of their features. Users 16, 18 can be assigned to a single cluster based on the distance from the user's feature vector to the cluster center (e.g., as represented by a mean feature vector for each cluster), or to two or more, or all clusters probabilistically. The parameters of the clustering algorithm, such as the cluster mean feature vectors, are stored for future predictions.

At S308, a reference behavior (e.g., a quota) qᵣ is computed for each of the clusters based on the consumption of the users assigned to that cluster (analogous to a role). Specifically, the role-based reference behavior qᵣ can be computed from the feature vectors (or print logs) for the users having a given cluster assignment. This completes the learning phase, which can be repeated and the clustering algorithm parameters and/or reference behaviors updated at any time.

In the quota estimation stage, a new (or existing) user 20 who needs to get a personalized quota q is introduced in the system. Based on features extracted from the user's print jobs, the probability of allocating the user to each role is computed using the clustering algorithm parameters. For example, at S310, print logs are acquired for the new user. At S312, a feature vector 82 is computed based on the new user's print logs, for the selected features. At S314, the new user's role probabilities Pᵣ are predicted by applying the clustering algorithm parameters to the user's feature vector 82. At S316, the quota qᵣ for each role computed at S308 is retrieved from memory and at S318, the new user's quota is computed, based on the retrieved role quotas and new user's role probabilities, e.g., with Eqn. 1.

Once the user's quota has been estimated, it can be used in scoring the user's behavior. For example, the actual usage can be computed (S320) and the user's score computed (S322) as the difference between the user's quota and the actual usage, optionally taking into account penalty features as described in US Pub. No. 20120033250. The method ends at S324.

A suitable clustering algorithm can be employed (in S306) to obtain predefined roles (groups or classes of behaviors) by grouping together users and features that tend to appear together. Example clustering algorithms include Non-negative Matrix Factorization (NMF), Probabilistic Latent Semantic Analysis (PLSA), and Latent Dirichlet Allocation (LDA). See, for example, Lee, “Algorithms for nonnegative matrix factorization,” Advances in Neural Information Processing Systems, 13:556-562, 2001; Hofmann, “Unsupervised learning by probabilistic latent semantic analysis,” Machine Learning, 42(1/2):177-196, 2001; and Blei, et al., “Latent dirichlet allocation,” J. Machine Learning Res., 3:993-1022, 2003, for a discussion of these techniques.

As suitable features for clustering, word occurrences in the title of the printed document have been found to be useful features to create homogeneous groups of users in some cases. Words may alternatively be extracted from the document content. A set of words may be identified which are useful for discriminating between roles. The frequencies of these words in each document printed by the user may be computed and aggregated to provide a feature value corresponding to each word. Feature vectors may be normalized so the values sum to 1.

As an example, in PLSA, a mixture model may be used in which the probability of a word w given a user u is expressed as a sum over a set of classes z of the probability of the word given a class and the probability of the class, given a user:

P_{LSA}(w|u)=Σ_{Z}P(w|z;θ)P(z|u;π)

where θ and π (and optionally also the number N of clusters) are parameters to be learned, e.g., via log-likelihood maximization which optimizes the values of the parameters. This can be approximated by expectation maximization. In the expectation step, the probability that the occurrence of word w of a user u can be explained by cluster z is computed given current values of the parameters.

$$P ( z \vert u , w ) = \frac{P ( z \vert u ; π ) P ( w \vert z ; θ )}{{\sum }_{{z}^{′}} P ( {z}^{′} \vert u ; π ) P ( w \vert {z}^{′} ; θ )}$$

In the maximization step, the parameters are re-estimated, based on the probabilities computed in the expectation step.

P(w|z,θ)∝Σᵤn(u,w)P(z|d,w),

where n(u,w)P(z|d,w) represents how often word w is associated with topic z, and

P(z|u,π)∝Σ_{w}n(u,w)P(z|u,w)

where n(u,w)P(z|u,w) represents how often user u is associated with topic z.

The two steps are iterated until convergence or until a stopping criterion is met.

The number of clusters may be predefined, e.g., in terms of an exact number of clusters or in terms of a maximum and/or minimum number of clusters. In other embodiments, the clustering algorithm is permitted to select an optimum number of clusters. The number of clusters may depend in part on the number of users. In general, the number of clusters is less than 50% of the number of users to be clustered.

Once clusters have been identified, the method can be similar to the supervised case.

The method illustrated in any one of FIGS. 2-4 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in any one of FIGS. 2-4, can be used to implement the exemplary method.

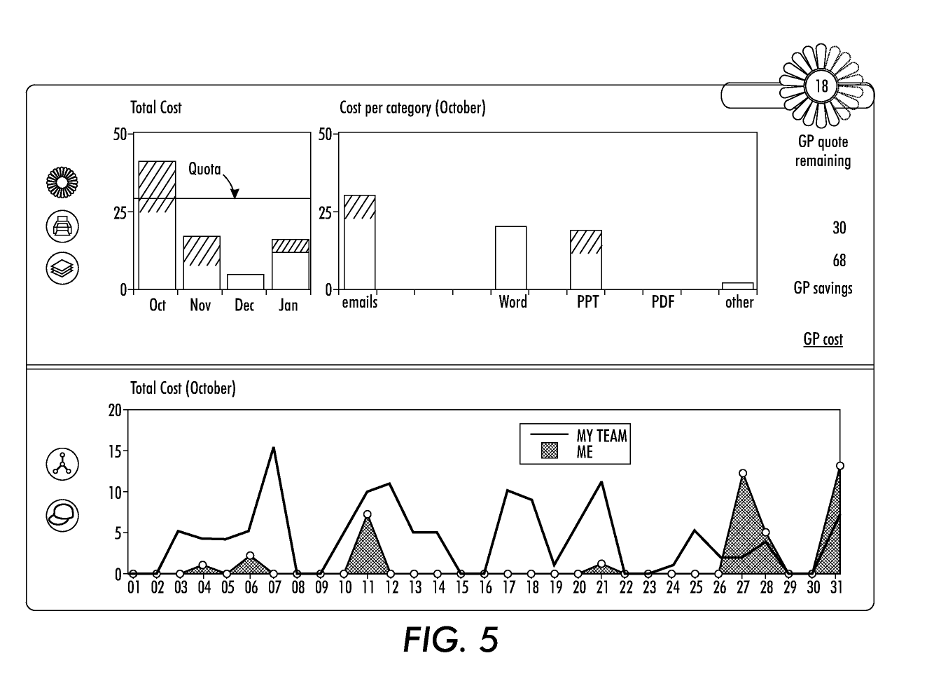

FIG. 5 illustrates an example graphical user interface 90 which may be displayed to the user. The user interface shows the cost in green points of the user's print jobs for each of the preceding three or four months and provides a comparison with other users for a selected month. The consumption may also be broken down by document category, such as emails, PDF, Word, PowerPoint, etc. The user's remaining quota may be displayed, as petals of a flower in the illustration.

While the exemplary method has been described in terms of device users, it is to be appreciated that the system and method are also applicable to the usage of a service by a pool of users. As for the device usage case, the users of the service(s) can be clustered/categorized and each individual user's quantity can be normalized by the average of his/her cluster (or a mixture thereof when clustering is soft). The classification/clustering of the users is learnt from a description of their usage of the service, typically provided by service logs.

Without intending to limit the scope of the exemplary embodiment, the following example illustrates the application of the method to data for an existing research organization.

### EXAMPLE

### Experiment data

Print logs were first collected over a period of several months for an existing set of users. Over the course of over a year, more than 45,000 printing actions were made by 169 unique users.

Table 1 lists a set of attributes which were extracted from the print logs, the type of data, and a short explanation. These attributes were retrieved with SQL queries from a print logs database.

TABLE 1
Print log attributes

| Name | Type | Explanation |
|---|---|---|
| username | string | user name (e.g., email address, name of user, |
| | | or other unique ID) |
| year | date | Year print job was submitted |
| month | date | Month print job was submitted |
| day | date | Day of month print job was submitted |
| hour | date | Hour of day print job was submitted |
| minute | date | Minute of hour print job was submitted |
| week | date | week of the year print job was submitted |
| weekday | date | day of the week print job was submitted |
| weekmonth | date | week of the month print job was submitted |
| app name | string | printed document application type (e.g., PDF, |
| | | PowerPoint, Text, etc.) |
| printer | string | printer name (or other unique ID for the printer to |
| | | which the job was submitted) |
| reprint | boolean | if a reprinted document, then 1, otherwise 0 |
| duplex | boolean | if printed mode is duplex, then 1, otherwise 0 |
| pagecount | numerical | number of pages per print |
| sheetcount | numerical | number of sheets per print |
| cost | numerical | cost of print |
| docname | string | title of the document |

Some preprocessing of the data was performed to reduce noise. For example, users very low printing activity were excluded from the dataset. These users were generally temporary employees, visitors, or virtual machines. To remove these users, a threshold number of days (10) of printing activity was established. This resulted in users with less than 10 days activity being removed.

Roles were manually assigned to the remaining users. In the exemplary embodiment, the users were labeled with 5 categories (roles) ranging from administrators to managers and researchers. Other users not fitting within these predefined roles were omitted from the dataset. The resulting dataset included 5 roles and 122 users. Each user was assigned one role in this example.

Having the attributes of each printing action (see Table 1) the next step (S208) was to decide which features to compute for the classifier 70. In the exemplary embodiment, as many features as possible were obtained and tested to see how discriminative they were (with respect to a given role). The initial list of features computed was as follows:

1. #sheets, #print jobs, average #of sheets per print job per different time-period:
a) per week of the year;
b) per month of the year;
c) per weekday;
d) per week of the month;
e) per hour;
f) per day interval (dividing into 6 intervals);
g) per hour interval (dividing into 6 intervals);

2. #sheets, #print jobs, average #of sheets per print job per type of printed document application:
a) Email;
b) MS Excel;
c) Graphics;
d) Other;
e) PDF;
f) MS PowerPoint;
g) RTF;
g) Text;
h) Visio;
i) Web;
j) MS Word;

3. #sheets, #prints, average #of sheets per print per printer (24 printers total).

This provided a total of 288 features for each user.

Some preprocessing was performed of the extracted features. Specifically, outliers were removed and feature values were normalized. Data normalization is useful, especially when the data scale is different, as it is in this case: the number of sheets per hour differs from a number of sheets per day. Normalization scaled all the features in the range [0,1]. However, it does not solve the outlier problem, which was partially reduced by clamping the extreme values using a Winsorizing technique, where values greater than the specified upper limit are replaced with the upper limit. In this case, the specified range was indicated in terms of percentiles of the original distribution (95th percentile).

To identify how discriminative features are to the user role classification, a statistical hypothesis test was used. The student t-test was performed for each feature by calculating the mean of one role and comparing it with the mean of the other roles. The decision whether to reject hypothesis or not was made according to the rule:

$$\vert t \vert > {t}_{( \frac{α}{2} )} ( n + m - 2 )$$

where t is the Student statistic,

α is the significant level (0.05 in the example embodiment),

n is the number of users having a first role i,

m is the number of users having any other role not i.

Based on the results, it was inferred that the day of the week on which printing occurred, the name of the printer used, and the type of printed document are useful indicators of the user's role, with the type of printed document being particularly informative. As may be expected, users assigned an “assistant” role tend to print significantly more emails and MS Excel files, since their job is related to performing administrational tasks, while “researchers” tend to print more PDF and MS Word files, probably because they read/write articles and papers.

After the t-test, the most discriminating feature groups were detected. One of the groups is application type. Usually document type and document name are closely related, therefore as another feature, document title was added. This feature computed title word frequencies for each user, but ignored, where possible, information on document type. The word features were computed in the following manner:

Each title string is divided into words including splitting words, when the case switches from lower into upper (“oneTwo” is split to “one Two”). Document extensions (everything that follows the last dot) are removed. Non-alphabetical symbols are removed, as well as words of only one letter. All words are switched to the lower case form. Stop words are removed by using English and French stop-words lists obtained from Tom Diethe, “Short course: Adaptive modelling of complex data,” 2009. Thereafter, a list of the most frequent words (top 1000) in the data was constructed. The method then involved computing and normalizing words frequencies for each user and composing a sparse matrix with words frequencies, where each row corresponds to a user and each column to a word in the top 1000 list.

To identify the most discriminative words, a hypothesis test about mean equality was performed, to see which words are the most discriminating for each role and evaluate whether the word features are useful in the classification. The sorted top words by the student t-value computed during the hypothesis test for each role were identified (in this case, the 30 most significant words describing each role). From a review of these words, it could be seen that the words appearing for each role are reasonable in that “assistants” print documents with titles including words like: chart, process, personnel, internal, memo, and plans, while for “researchers,” the most significant words include publication, assignment, paper, and submission. This analysis suggests that word features are useful for distinguishing different roles as well.

As will be appreciated, the words used to generate word features may be extracted from the document itself e.g., from the first line, page, paragraph, or the like, particularly when the organization uses a document management system in which document titles are not used or are not as informative.

Having selected a set of discriminative features, the next step is to obtain training data in order to obtain the model which will compute personal quotas and scores.

1. Supervised Learning

In this example, a supervised learning approach was used to build a classifier model 86, for assigning role probabilities for a new user. Once the model was built, a test set of print job data was sent to the system to predict the roles of the users. The model 86 outputs the probabilities for each role. Then each of probabilities is multiplied by the average consumption of the corresponding role. To obtain the individual's quota the multiplication results are summed. The user's score is then computed as the relative difference between the personalized quota and the real consumption of the user. If it is negative, the user exceeds the quota, if it is positive, the user's behavior is considered environmentally friendly.

To select a suitable algorithm for multiclass classification Support Vector Machine with Sequential Minimal Optimization (SMO), Logistic Regression and Fisher Linear Discriminant classifiers were evaluated by their classification accuracy. Regularization parameters were tuned for the SVM and FLD cases. By performing cross validation for SVM, a regularization parameter of C=5 and a suitable kernel function−Normalized PolyKernel, were identified. This reduced the error rate. However, linear kernel or RBF kernel may also be used and a regularization parameter of from C=1 to 50. For FLD, a regularization parameter of 2 was identified, although values of from 0.1 to 2.2 could also be used.

For comparison of the different supervised classifiers, the data were split into the training and testing data in the ratio 3:1. Thus in the training data there were 78 users, while in the testing set there were 39 users. Resampling was applied and the median and minimum of classification error were found for each method (see Table 2).

TABLE 2
Classification Error

| Method | Min of Error (%) | Median of Error (%) |
|---|---|---|
| SMO | 23.08 | 41.54 |
| Logistic | 34.15 | 56.10 |
| FLD | 30.07 | 50.24 |

For the example data, this suggests that SVM with SMO provides the best performance. The relatively high error is due to a very small data sample (for this case there are just 122 examples), consequently each time the training and test set is randomly split, the results are heavily dependent on the particular split. Even though the obtained SMO median classification error is not very low, it is still lower than it would be by predicting just one dominant role.

To get the estimate of the quota and to measure its accuracy, a bootstrapping method was used according to the method of Wehrens, et al., “The bootstrap: a tutorial,” Chemometrics and Intelligent Laboratory Systems, 54(1):35-52, 2000. The number of resamples was chosen to be the same as the number of users in the dataset. To measure the accuracy, the confidence interval was chosen. The estimate of quota and score are the medians of both quotas and scores obtained within each iteration.

2. Unsupervised Learning

Here, it was assumed that there is no possibility to obtain the a priori roles. In this method, the feature selection is omitted, since it is not possible to indicate most discriminant features for each role. However, based on the observation above that document title can be very discriminative feature it was selected as a feature for unsupervised learning. Thus, for the unsupervised case, a bag of words is used to compute the feature matrix of the most frequent words, containing the frequencies of each word for each user. The model assigns the quota and score to the user based on the average of the real consumptions of the similar users.

Probabilistic Latent Semantic Analysis (PLSA) was used to smooth the data since the observed data corresponds to co-occurrences of discrete variables. In this case, there are two parameters to tune: the number of clusters and the number of nearest neighbors. The decision was made by trying several values and comparing the results of the supervised classification. The comparison showed that suitable values are 5 clusters and 15 nearest neighbors. However, a deeper analysis and cross-validation may be employed to obtain the most suitable values. The cross-validation may be done with the data for the new users.

### Results

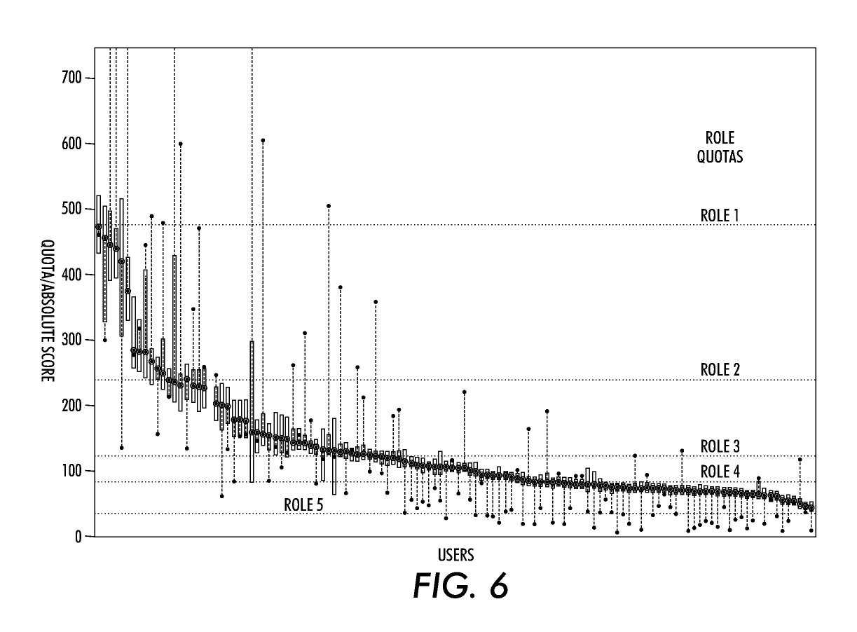

FIG. 6 shows the personal quota for each user, in the supervised case. Roles are identified as 1-5.

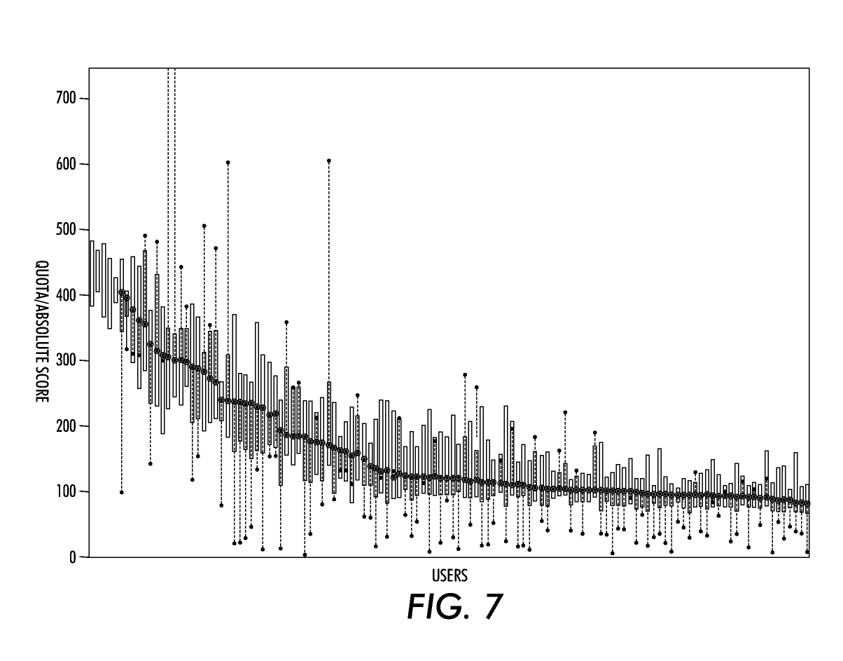

FIG. 7 shows the personal quota for each user and absolute score (dotted lines), in the unsupervised case.

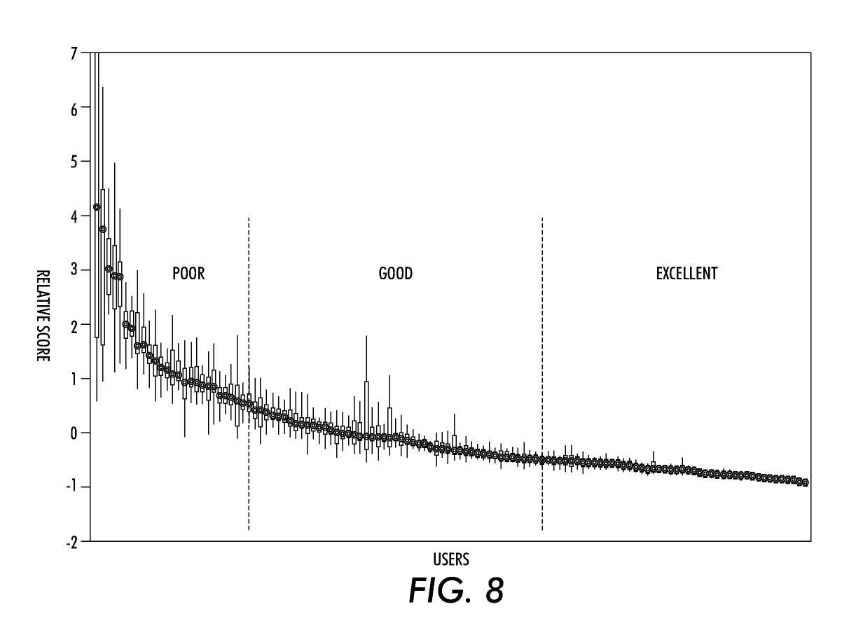

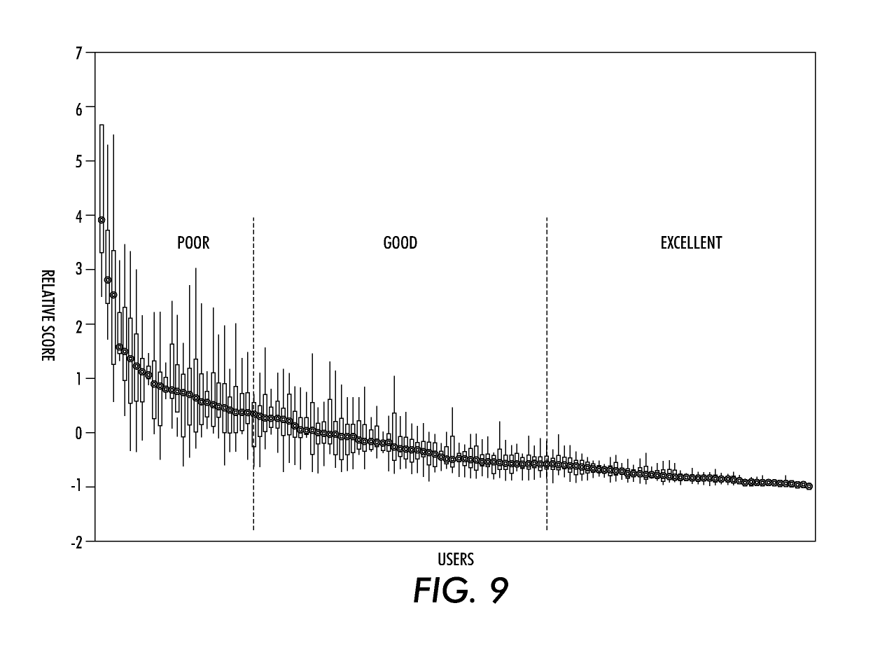

FIGS. 8 and 9 show the relative scores of the users. The relative scores are computed with the following formula: (consumption−quota)/quota. Thus if (1) the user's consumption is greater than the user's quota, the resulting value will be >0, i.e. the user has consumed more than expected; if (2) consumption is equal to the quota, the resulting value will be =0, the user has consumed as expected; and if (3) the consumption is less than the quota, the resulting value <0, the user has consumed less than expected.

Users may be classified based on their relative scores (and the associated confidence interval) and be provided feedback based on their relative scores, such as “poor,” “good”, “excellent”.

The results showed that the performance of the best initial features (the name of the printer used, and the type of printed document) could be improved by adding the matrix of word frequencies for each user as a feature. The best supervised classifier, Support Vector Machine with Sequential Minimal Optimization method, outperformed Logistic Regression and Fisher Linear Discriminant Analysis. Probabilistic Latent Semantic Analysis was chosen for the unsupervised learning. It enables unobserved patterns to be discovered, in this case, users having similar printing behavior. Because of the lack of training samples, the prediction error can vary considerably, however the quota and score estimates can still be used, by taking into account their confidence band. Bootstrapping techniques give confidence intervals, with a reasonable amount of samples (around 100 bootstrap samples).

The results demonstrate that the exemplary method improves the computation of the personal quotas and scores for the users allowing enhanced feedback to be provided on their printing behavior. The supervised model can be applied when user roles are defined, while the unsupervised model can be applied without labeled data. By employing those models, scores which better reflect each user's expected behavior can be computed.

Once computed the resulting reference behavior can also be used as a basis for defining print governance rules that introduce a hard printing consumption limit for its users. These rules and the corresponding limits are currently defined manually by an administrator, which constitutes a difficult and time-consuming task.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for computing a reference behavior for a new user comprising:
acquiring usage data for an initial set of device or service users;
extracting features from the usage data;
learning a model with the extracted features for predicting a user role profile for a new user based on features extracted from the new user's usage data, the user role profile associating the user with at least one of a set of roles;
receiving a new user's usage data;
with the trained model, predicting a user role profile for the new user based on features extracted from the new user's usage data; and
computing a reference behavior for the new user based on the predicted user role profile and the reference behaviors for roles in the set of roles,
wherein at least one of the acquiring, extracting, learning, receiving, assigning and computing is performed with a computer processor.

2. The method of claim 1, wherein the usage data comprises print job data for a set of printers.

3. The method of claim 2, wherein the features include a plurality of features for each user in the initial set, the plurality of features being selected from the group consisting of:
number of sheets printed per predefined time period;
number of print jobs per predefined time period;
average number of sheets per print job per predefined job type;
number of sheets printed per predefined job type;
number of print jobs per predefined job type;
average number of sheets per print job per predefined job type;
number of sheets printed per predefined printer;
number of print jobs per predefined printer;
average number of sheets per print job per predefined printer;
textual content features extracted from the title or content of the printed document; and
combinations thereof.

4. The method of claim 3, wherein the job types include job types which are selected from the group consisting of Email; spreadsheet; graphics; PDF; PowerPoint; RTF; Text; drawing program; Web; Word; and combinations thereof.

5. The method of claim 1, wherein the learning of the model comprises supervised learning of a classifier model based on the extracted features and predefined roles of the users in the initial set of users.

6. The method of claim 1, wherein the learning of the model comprises unsupervised learning with a clustering algorithm which clusters users in the initial set of users into clusters based on the extracted features, each cluster being considered as representing a respective role.

7. The method of claim 1, wherein the user role profile associates the new user with a probability for each of the set of roles.

8. The method of claim 7, wherein the computing of the reference behavior for the new user comprises computing a function of the probabilities and the reference behaviors for each of the roles.

9. The method of claim 1, further comprising computing the reference behavior for each role in the set of roles based on usage data for users in the initial set of users which are assigned the respective role.

10. The method of claim 1, further comprising identifying features which differentiate between roles and wherein the extracted features include the identified features.

11. The method of claim 1, further comprising computing a score for the new user based on the reference behavior for the new user and an actual behavior for the new user.

12. The method of claim 1, wherein the reference behavior is expressed in terms of at least one of a number of sheets printed, a number of pages printed, and a cost which computed as a function of at least one of a number of sheets printed and a number of pages printed as well as a penalty term for taking into account at least one predefined printing behavior.

13. The method of claim 1, further comprising generating a user interface for display to the new user on a respective client device which compares the new user's reference behavior with an actual usage behavior of the new user.

14. A computer program product comprising a non-transitory recording medium storing instructions, which when executed by a computer processor, perform the method of claim 1.

15. A system for computing a reference behavior for a new user comprising:
a feature extractor for extracting features from usage data acquired for users of an associated set of shared devices;
a role assignment component for assigning a user role profile to a new user based on features extracted from the new user's usage data, the user role profile associating the new user with at least one of a set of roles, the role assignment component employing a model learnt using features extracted from usage data of an initial set of users;
a user quota component for computing a reference behavior for the new user based on the user role profile and the reference behaviors for roles in the set of roles; and
a processor which implements at least one of the feature extractor, role assignment component, and user quota component.

16. The system of claim 15, wherein the usage data comprises print job data and the set of associated devices comprises a set of printers.

17. The system of claim 15, further comprising a component for learning the model.

18. The system of claim 15, further comprising a component for computing the reference behavior for each role in the set of roles based on usage data for users in the initial set of users which are assigned the respective role.

19. The system of claim 15, further comprising a feature selector for identifying features which differentiate between roles.

20. The system of claim 15, further comprising a scoring component for computing a score for the new user based on the reference behavior for the new user and an actual behavior for the new user.

21. A method for computing a printing quota for a user comprising:
providing a model for predicting a user role profile for a user based on features extracted from the user's print job data, the user role profile associating the user with at least one of a set of roles, the model having been learned on features extracted from print job data acquired for a set of print jobs for each user in an initial set of multiple users;
receiving a new user's usage data;
with the trained model, predicting a user profile for the new user based on features extracted from the new user's usage data, the user profile assigning a probability to each of the roles in the set of roles; and
with a processor, computing a printing quota for the new user based on the user role profile and reference quotas for each of the roles in the set of roles.
